(19) United States
(12) Patent Application Publication
(10) Pub. No.: US 2008/0019647 A1
(43) Pub. Date: Jan. 24, 2008

(54) Optical Fiber Tape Unit And Optical Fiber Cable

(76) Inventors: Takahiro Sato, Hitachi (JP); Yoshihiro Kodaka, Ibaraki (JP); Hideyuki Nozawa, Hitachinaka (JP); Chihiro Ohkubo, Hitachi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/578,333

(22) PCT Filed: Apr. 12, 2005
(86) PCT No.: PCT/JP05/07103

§ 371 Date: Dec. 27, 2006

(30) Foreign Application Priority Data
Apr. 14, 2004 (JP) 2004-119187

(51) Int. Cl. G02B 6/44

(52) U.S. Cl. 385/112; 385/113

(57) ABSTRACT

An optical fiber tape unit comprising an optical fiber core having an outer diameter of 0.4 mm or more consisting of an optical fiber strand composed of an optical fiber, a primary coating layer and a secondary coating layer, and an overcoat layer formed around the outer circumference of the optical fiber strand, and a member for coupling a plurality of optical fiber cores arranged in parallel. Assuming that the overcoat layer has a Young's modulus E1, a cross-sectional area A1, a tensile strength TS1 and a tensile elongation TE1 and the coupling member has a Young's modulus E2, a cross-sectional area A2, a tensile strength TS2 and a tensile elongation TE2, following relations are satisfied: following relations are satisfied: E1·A1≧E2·A2, TS1≧TS2, TE1≧TE2, E1≧100 (MPa), 20≦E2≦300 (MPa), TS1≧10 (MPa), TS2≦40 (MPa), TE1≧30(%), and TE2≦40(%).

### TECHNICAL FIELD

The present invention relates to an optical fiber tape unit and an optical fiber cable, and more particularly, to an optical fiber tape unit and an optical fiber cable integrating a plurality of optical fiber cores with an increased diameter.

### BACKGROUND ART

The present application is based on Japanese Patent Application No. 2004-119187, the entire contents of which are incorporated herein by reference.

FTTH (Fiber To The Home), specifically, the optical fiber cable which enables ultra high-speed and a large capacity communication in each home, office, or the like has been introduced in recent years.

Japanese Patent Laid-Open No. 2001-343571 discloses this kind of optical fiber cable.

Patent document 1: Japanese Patent Laid-Open No. 2001-343571

FIG. 7 discloses the structure of this optical fiber cable. A cable part 18 is construed by arranging four optical fiber colored strands (not shown) with an outer diameter of about 0.25 mm in parallel with a pitch of the outer diameter of the optical fiber colored strand and bundling them together with an ultraviolet curing resin to provide a tape type optical fiber core 9, assembling (tape-laminating) plural pieces of this tape type optical fiber cores 9, twisting them to be assembled with a constant pitch in one direction, wrapping an assembled body with a plastic tape 22, and forming a sheath 20 thereon. Two tension members 23 composed of steel wire are longitudinally provided on both of upper and lower sides in the sheath 20.

On the other hand, a supporting line part 19 is constituted by forming a sheath 25 around an outer circumference of a tension member composed of six steel wires twisted and assembled around one steel wire.

Further, a neck part 24 having slits (not shown) at a constant interval is formed between the cable part 18 and the supporting line part 19, such that a loose rate of the cable part 18 against the supporting line part 19 may become 0.2% or more. In general, the sheath 20 in the cable part 18, the sheath 25 of the supporting line part 19, and the neck part 24 are formed simultaneously by extruding and coating a thermoplastic resin sheath comprising, for example, a low density polyethylene.

There is a case that the sheath 20 is stripped off in a cable intermediate part to take out an arbitrary optical fiber colored strand, after the conventional optical fiber cable as shown in FIG. 7 is installed (intermediate/post-branching process). To separate the optical fiber colored strand from the tape type optical fiber core 9 in this process, a specialized tool is required since the optical fiber colored strand is very thin such as about 0.25 mm. However, the workability is still bad even using the specialized tool and the increase of an optical fiber loss might be occurred while at work. In the worst case, the optical fiber colored strand might be possibly disconnected. Further, in a case where handling the fiber colored strand after separating the optical fiber colored strand, it is difficult to identify each optical fiber colored strand, since the optical fiber colored strand is very thin, therefore the optical fiber might be possibly cut by mistake.

It is an object of the present invention to provide an optical fiber tape unit and an optical fiber cable having an excellent single core separation performance, in which the process to separate the tape type optical fiber core comprising plural strands (single cores) into single strands (single core) can be conducted easily by manual, and the optical fiber can be easily identified during or after single core separation so that the cutting accident can be prevented as much as possible.

According to one aspect of the present invention, an optical fiber tape unit comprises:

an optical fiber core with an outer diameter of 0.4 mm or more, the optical fiber core including an optical fiber strand composed of an optical fiber, a primary coating layer and a secondary coating layer, and an overcoat layer formed around an outer circumference of the optical fiber strand; and

a connecting member for connecting a plurality of the optical fiber cores arranged in parallel;

wherein:

following relations are satisfied:
E1·A1≧E2·A2,
TS1≧TS2,
TE1≧TE2,
E1≧100 (MPa),
20≦E2≦300 (MPa)
TS1≧10 (MPa)
TS2≦40 (MPa),
TE1≧30(%), and
TE2≦40(%),

When the overcoat layer has a Young's modulus E1, a cross-sectional area A1, a tensile strength TS1 and a tensile elongation TE1, and the connecting member has a Young's modulus E2, a cross-sectional area A2, a tensile strength TS2 and a tensile elongation TE2.

At least one of the overcoat layer and the connecting member may contain a parting agent.

The optical fiber strand may be provided with a colored layer formed around an outer circumference of the secondary coating layer.

The overcoat layer and the connecting member may be composed of a thermosetting resin or a thermoplastic resin.

The overcoat layer may be composed of a transparent material.

The overcoat layer may be colored by mixing a colorant.

The connecting member may be transparent.

The connecting member may be colored by mixing a colorant.

The connecting member may have a stripe-shaped color band.

The connecting member may be formed on both sides that correspond to long sides of a substantially rectangular cross-section formed by arranging a plurality of the optical fiber cores in parallel.

The connecting member may be formed on one side corresponds to a long side of a substantially rectangular cross-section formed by arranging a plurality of the optical fiber cores in parallel.

The connecting member may be formed only on a concave portion between a plurality of the optical fiber cores arranged in parallel.

According to another aspect of the invention, an optical fiber cable formed to be a cable by assembling one or more of the optical fiber tape units.

### EFFECTS OF THE INVENTION

In the optical fiber tape unit according to the present invention, an optical fiber core provided with an overcoat layer to have an outer diameter of 0.4 mm or more is used, and a plurality of the optical fiber cores are arranged in parallel and connected by a connecting member in that following relations are satisfied: E1·A1≧E2·A2, TS1≧TS2, and TE1≧TE2, when the overcoat layer has a Young's modulus E1, a cross-sectional area A1, a tensile strength TS1 and a tensile elongation TE1, and the connecting member has a Young's modulus E2, a cross-sectional area A2, a tensile strength TS2 and a tensile elongation TE2. According to this structure, since the overcoat layer in the optical fiber core becomes stronger than the connecting member, the single core separation process can be conducted by destroying only the connecting member without destroying the overcoat layer during the single core separation process.

Further, the strength of the connecting member is determined to satisfy the relations: E2≦300 (MPa), TS2≧40 (MPa), TE2≦40 (%), the heavy load is not applied to the optical fiber tape unit during the single core separation process so that the single core separation process by hand work can be realized and the increase of transmission loss can be prevented.

Further, by providing the overcoat layer and the coupling member to satisfy the relations: E1≧100 (MPa), TS1≧10 (MPa), TE1 ≧30(%), and E2≧20 (MPa), the occurrence of the damage or the like on the optical fiber tape unit 12 can be prevented at the time of conducting the optical fiber tape unit cabling (to make cable).

Further, since the diameter of the optical fiber core is increased to be 0.4 mm or more, it becomes easy to handle and to identify the optical fiber core.

Further, the single core separation performance can be further improved by mixing the parting agent with either one or both of the overcoat layer and the connecting member.

Further, when the overcoat layer is composed of a transparent material, the optical fiber core can be identified easily.

Further, when the overcoat layer is composed of a material colored by mixing a colorant, the optical fiber core can be identified easily.

Further, when the stripe shaped color band is provided on the connecting member, the optical fiber core or the optical fiber tape unit can be identified easily.

Further, when the connecting member is composed of a transparent material, the optical fiber core in the optical fiber tape unit can be identified easily.

Further, when the connecting member is composed of a material colored by mixing a colorant, the optical fiber core or the optical fiber tape unit can be identified easily.

Further, when the connecting member is provided with the stripe shaped color band, the optical fiber core or the optical fiber tape unit can be identified easily.

Since the optical fiber tape unit is used, the optical fiber cable according to the present invention can be easily handled when branching.

### BRIEF DESCRIPTION OF THE DRAWINGS

FIG. 1 is a schematic cross-sectional view showing a preferred embodiment of the optical fiber core used for the optical fiber tape unit according to the invention;

FIG. 2 is a schematic cross-sectional view showing the optical fiber tape unit in the first preferred embodiment according to the invention;

FIG. 3 is a schematic cross-sectional view showing the optical fiber tape unit in the second preferred embodiment according to the invention;

FIG. 4 is a schematic cross-sectional view showing the optical fiber tape unit in the third preferred embodiment according to the invention;

FIG. 5 is a schematic cross-sectional view showing the optical fiber tape unit in the fourth preferred embodiment according to the invention;

FIG. 6 is a schematic cross-sectional view showing the optical fiber cable in the preferred embodiment according to the invention;

FIG. 7 is a schematic cross-sectional view showing a conventional optical fiber cable;

FIG. 8 is a schematic cross-sectional view showing a method of conducting a coating removal test of the optical fiber core; and

FIG. 9 is a schematic cross-sectional view showing an optical fiber cable in another preferred embodiment according to the invention.

### BEST MODE FOR CARRYING OUT THE INVENTION

Next, preferred embodiments of the present invention will be described below in more detail in conjunction with the appended drawings.

The Young's modulus described in this specification is a value at a normal temperature (23° C.).

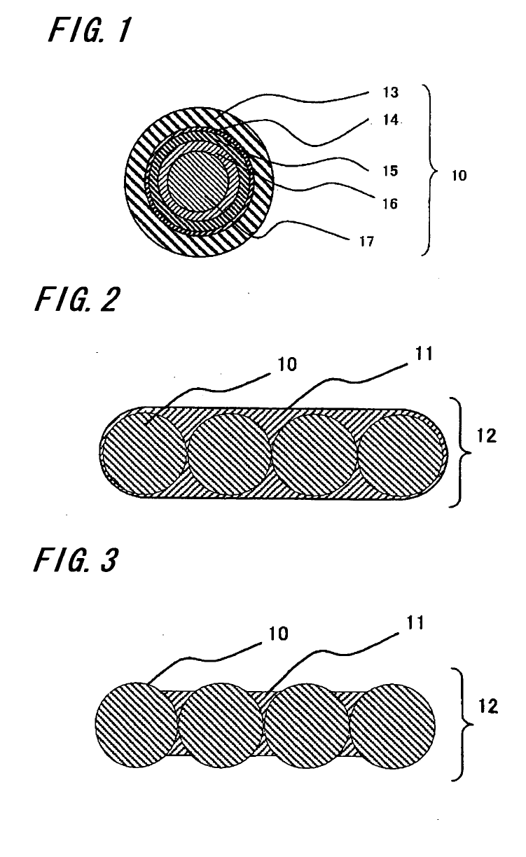

FIG. 1 is a schematic cross-sectional view showing a preferred embodiment of the optical fiber core used for the optical fiber tape unit according to the invention.

As shown in FIG. 1, an optical fiber core 10 used for the invention comprises an optical fiber 17 including a core and a clad, a primary coating layer 16, a secondary coating layer 15, a colored layer 14, and an overcoat layer 13, and has an outer diameter of 0.4 mm or more. Instead of providing the colored layer, the secondary coating layer may be colored by mixing a colorant. A parting agent may be mixed into the overcoat layer.

FIG. 2 is a schematic cross-sectional view showing the optical fiber tape unit in the first preferred embodiment according to the invention.

As shown in FIG. 2, an optical fiber tape unit 12 in this preferred embodiment is constituted by connecting a plurality of the optical fiber cores 10 arranged in parallel and a connecting member 11 provided around an outer circumference thereof. The overcoat layer and the connecting member are formed by using an ultraviolet curing resin, the thermosetting resin or the thermoplastic resin, etc. A parting agent may mixed into the connecting member. In the optical fiber tape unit 12, the following relations are satisfied:

wherein:

following relations are satisfied:
E1·A1≧E2·A2,
TS1≧TS2,
TE1≧TE2,
E1≧100 (MPa),
20≦E2≦300 (MPa)
TS1≧10 (MPa)
TS2≦40 (MPa),
TE1≧30(%), and
TE2≦40(%),

When the overcoat layer has a Young's modulus E1, a cross-sectional area A1, a tensile strength TS1 and a tensile elongation TE1, and the connecting member has a Young's modulus E2, a cross-sectional area A2, a tensile strength TS2 and a tensile elongation TE2.

FIG. 3 is a schematic cross-sectional view showing the optical fiber tape unit in the second preferred embodiment according to the invention.

As shown in FIG. 3, the optical fiber tape unit 12 in this preferred embodiment is constituted by connecting a plurality of the optical fiber cores 10 arranged in parallel and the connecting member 11 provided only on a concave portion between the optical fiber cores around an outer circumference thereof.

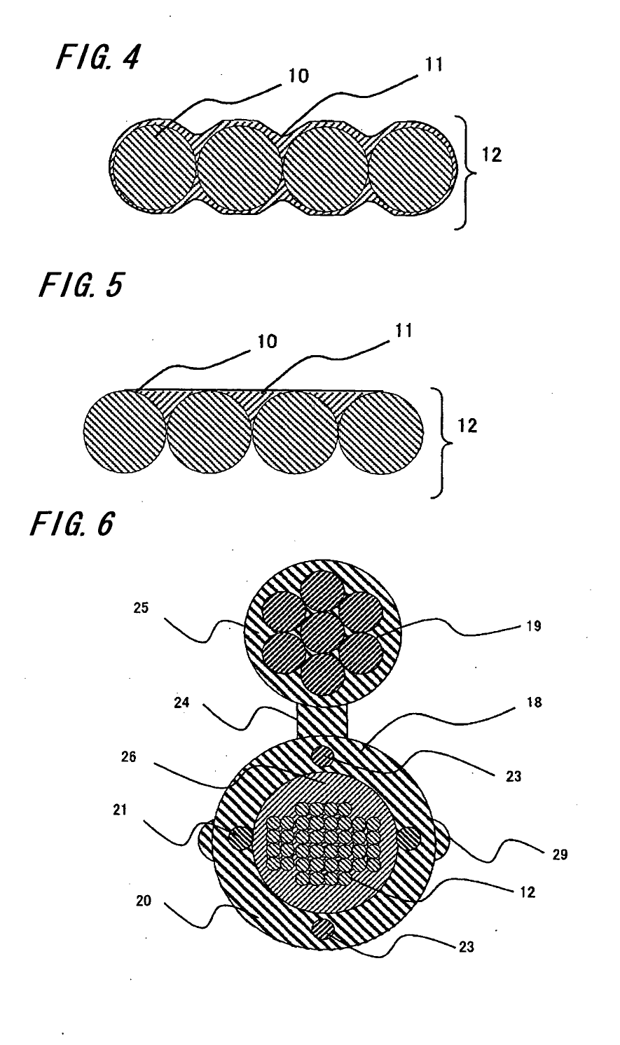

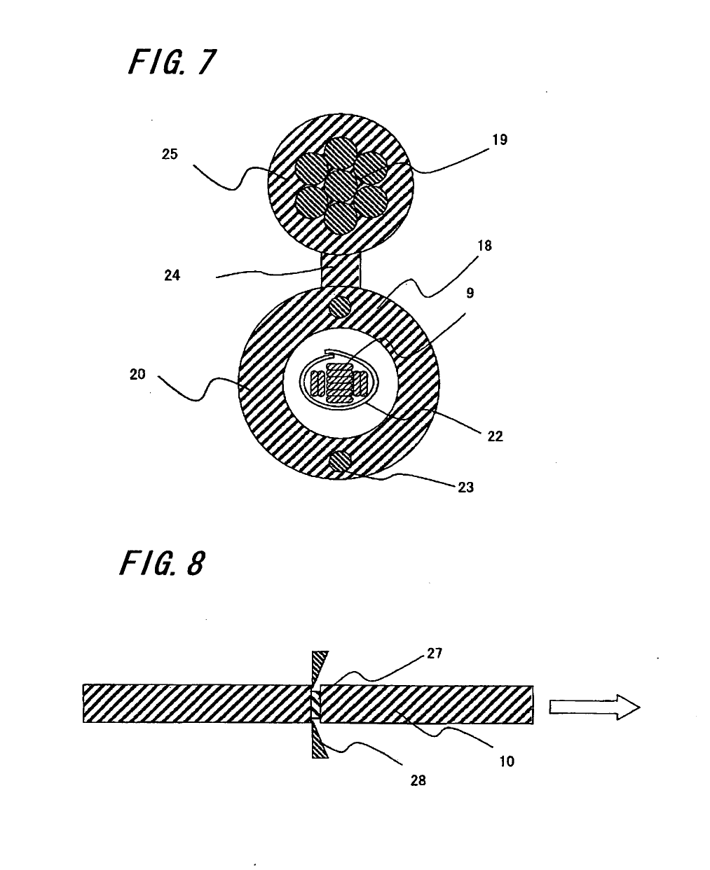

FIG. 4 is a schematic cross-sectional view showing the optical fiber tape unit in the third preferred embodiment according to the invention.

As shown in FIG. 4, the optical fiber tape unit 12 in this preferred embodiment is constituted by connecting a plurality of the optical fiber cores 10 arranged in parallel and the connecting member 11 provided around an outer circumference thereof to have a substantially equal thickness.

FIG. 5 is a schematic cross-sectional view showing the optical fiber tape unit in the fourth preferred embodiment according to the invention.

As shown in FIG. 5, the optical fiber tape unit 12 in this preferred embodiment is constituted by connecting a plurality of the optical fiber cores 10 arranged in parallel and the connecting member 11 provided only on the concave portion between the optical fiber cores of one side of an outer circumference thereof.

The optical fiber tape unit of the invention is not limited to the above preferred embodiments, and it is enough if the following relations are satisfied:
E1·A1≧E2·A2,
TS1≧TS2,
TE1≧TE2,
E1≧100 (MPa),
20≦E2≦300 (MPa)
TS1≧10 (MPa)
TS2≦40 (MPa),
TE1≧30(%), and
TE2≦40(%),

When the overcoat layer has a Young's modulus E1, a cross-sectional area A1, a tensile strength TS1 and a tensile elongation TE1, and the connecting member has a Young's modulus E2, a cross-sectional area A2, a tensile strength TS2 and a tensile elongation TE2.

FIG. 6 is a schematic cross-sectional view showing the optical fiber cable in the preferred embodiment according to the invention.

As shown in FIG. 6, the optical fiber cable in this preferred embodiment comprises a cable part 18 construed by assembling (tape-laminating) plural pieces of the optical fiber tape units according to any one of the preferred embodiments, twisting them with a filler 26, longitudinally providing two tension members 23 on both of upper and lower sides, and providing a sheath 20 thereon; a supporting line part 19 constituted by forming a sheath 25 around an outer circumference of a tension member composed of six steel wires twisted and assembled around one steel wire; and a neck part 24 having slits at a constant interval formed between the cable part 18 and the supporting line part 19, such that a loose rate of the cable part 18 against the supporting line part 19 may become 0.2% or more.

### EXAMPLE 1

Plural types of samples of 4-core optical fiber tape unit were manufactured experimentally, and the result of cabling (making cable) was examined. Table 1 shows the result. The cabling result “x” shows that the damage or the like was generated on the optical fiber tape unit.

TABLE 1

| Item | A | | B | | C | | D | | E | |
|---|---|---|---|---|---|---|---|---|---|---|
| the outer diameter of | 0.5 | mm | 0.6 | mm | 0.5 | mm | 0.5 | mm | 0.5 | mm |
| the optical fiber core | | | | | | | | | | |
| Young's modulus E1 of | 230 | MPa | 600 | MPa | 600 | MPa | 600 | MPa | 600 | MPa |
| the overcoat layer | | | | | | | | | | |
| Cross-sectional area A1 | 0.581 | mm² | 0.927 | mm² | 0.581 | mm² | 0.581 | mm² | 0.581 | mm² |
| of the overcoat layer | | | | | | | | | | |
| (total of four) | | | | | | | | | | |
| Tensile strength TS1 of | 31 | MPa | 30 | MPa | 30 | MPa | 30 | MPa | 30 | MPa |
| the overcoat layer | | | | | | | | | | |
| Tensile elongation TE1 | 38% | | 47% | | 47% | | 47% | | 47% | |
| of the overcoat layer | | | | | | | | | | |
| Young's modulus E2 of | 75 | MPa | 280 | MPa | 880 | MPa | 770 | MPa | 620 | MPa |
| the connecting member | | | | | | | | | | |
| Cross-sectional area A2 | 0.411 | mm² | 0.491 | mm² | 0.411 | mm² | 0.411 | mm² | 0.411 | mm² |
| of the connecting member | | | | | | | | | | |
| Tensile strength TS2 of | 13 | MPa | 23 | MPa | 29 | MPa | 42 | MPa | 28 | MPa |
| the connecting member | | | | | | | | | | |

| | | | | | |
|---|---|---|---|---|---|
| Tensile elongation TE2 | 22% | 24% | 35% | 38% | 55% |
| of the connecting member | | | | | |
| E1A1 ≧ E2A2 | ◯ | ◯ | X | ◯ | ◯ |
| TS1 ≧ TS2 | ◯ | ◯ | ◯ | X | ◯ |
| TE1 ≧ TE2 | ◯ | ◯ | ◯ | ◯ | X |
| Single core separation | ◯ | ◯ | X | X | X |
| evaluation | | | | | |

From the result of table 1, it is admitted that the single core separation process of the optical fiber tape unit can be conducted without destroying the overcoat layer, when the relation between the Young's modulus E1, a cross-sectional area A1, a tensile strength TS1 of the overcoat layer of the optical fiber core and a tensile elongation TE1 and the Young's modulus E2, a cross-sectional area A2, a tensile strength TS2 and a tensile elongation TE2 of the connection member 11 of the optical fiber tape unit are determined to satisfy that E1·A1≧E2·A2, TS1≧TS2, and TE1≧TE2.

### EXAMPLE 2

Plural types of samples of the 4-core optical fiber tape unit were manufactured experimentally, and the single core separation evaluation was conducted by the single core separation process. Table 2 shows the result. The single core separation evaluation “◯” shows that the single core separation can be conducted by the hand work without using the tool during the single core separation process and that the increase of transmission loss was not occurred.

TABLE 2

| Item | A | | B | | C | | D | | E | |
|---|---|---|---|---|---|---|---|---|---|---|
| the outer diameter of | 0.5 | mm | 0.6 | mm | 0.5 | mm | 0.5 | mm | 0.5 | mm |
| the optical fiber core | | | | | | | | | | |
| Young's modulus E1 of | 230 | MPa | 600 | MPa | 600 | MPa | 230 | MPa | 230 | MPa |
| the overcoat layer | | | | | | | | | | |
| Cross-sectional area A1 | 0.581 | mm² | 0.927 | mm² | 0.581 | mm² | 0.581 | mm² | 0.581 | mm² |
| of the overcoat layer | | | | | | | | | | |
| (total of four) | | | | | | | | | | |
| Tensile strength TS1 of | 31 | MPa | 30 | MPa | 30 | MPa | 31 | MPa | 31 | MPa |
| the overcoat layer | | | | | | | | | | |
| Tensile elongation TE1 | 38% | | 47% | | 47% | | 38% | | 38% | |
| of the overcoat layer | | | | | | | | | | |
| Young's modulus E2 of | 75 | MPa | 280 | MPa | 380 | MPa | 280 | MPa | 220 | MPa |
| the connecting member | | | | | | | | | | |
| Cross-sectional area A2 | 0.411 | mm² | 0.491 | mm² | 0.411 | mm² | 0.411 | mm² | 0.411 | mm² |
| of the connecting member | | | | | | | | | | |
| Tensile strength TS2 of | 13 | MPa | 23 | MPa | 32 | MPa | 44 | MPa | 28 | MPa |
| the connecting member | | | | | | | | | | |

| | | | | | |
|---|---|---|---|---|---|
| Tensile elongation TE2 | 22% | 24% | 38% | 36% | 55% |
| of the connecting member | | | | | |
| E2 ≦ E300 (MPa) | ◯ | ◯ | X | ◯ | ◯ |
| TS2 ≦ 40 (MPa) | ◯ | ◯ | ◯ | X | ◯ |
| TE2 ≦ 40 (%) | ◯ | ◯ | ◯ | ◯ | X |
| Single core separation | ◯ | ◯ | X | X | X |
| evaluation | | | | | |

From the result of table 2, it is admitted that the single core separation process of the optical fiber unit can be conducted by the hand work and the increase of transmission loss can be prevented by using the connecting member of the optical fiber unit in which the Young's modulus E2, a tensile strength TS2, a tensile elongation E2 satisfy the relations E2≦300 (MPa) TS2≦40 (MPa), and TE2≦40(%) w.

### EXAMPLE 3

Plural types of samples of the 4-core optical fiber tape unit were manufactured experimentally, and the result of cabling (to make cable) was examined. Table 3 shows the result. The cabling result “x” shows that the damage or the like was generated on the optical fiber tape unit.

TABLE 3

| Item | A | | B | | C | | D | | E | |
|---|---|---|---|---|---|---|---|---|---|---|
| the outer diameter of | 0.5 | mm | 0.6 | mm | 0.5 | mm | 0.5 | mm | 0.5 | mm |
| the optical fiber core | | | | | | | | | | |
| Young's modulus E1 of | 230 | MPa | 85 | MPa | 120 | MPa | 130 | MPa | 230 | MPa |
| the overcoat layer | | | | | | | | | | |
| Cross-sectional area A1 | 0.581 | mm² | 0.927 | mm² | 0.581 | mm² | 0.581 | mm² | 0.581 | mm² |
| of the overcoat layer | | | | | | | | | | |
| (total of four) | | | | | | | | | | |
| Tensile strength TS1 of | 31 | MPa | 13 | MPa | 8 | MPa | 12 | MPa | 31 | MPa |
| the overcoat layer | | | | | | | | | | |
| Tensile elongation TE1 | 38% | | 32% | | 35% | | 26% | | 38% | |
| of the overcoat layer | | | | | | | | | | |
| Young's modulus E2 of | 75 | MPa | 280 | MPa | 75 | MPa | 75 | MPa | 8 | MPa |
| the connecting member | | | | | | | | | | |
| Cross-sectional area A2 | 0.411 | mm² | 0.491 | mm² | 0.411 | mm² | 0.411 | mm² | 0.411 | mm² |
| of the connecting member | | | | | | | | | | |
| Tensile strength TS2 of | 13 | MPa | 23 | MPa | 13 | MPa | 13 | MPa | 2 | MPa |
| the connecting member | | | | | | | | | | |

| | | | | | |
|---|---|---|---|---|---|
| Tensile elongation TE2 | 22% | 24% | 22% | 22% | 38% |
| of the connecting member | | | | | |
| E1 ≧ 100(MPa) | ◯ | X | ◯ | ◯ | ◯ |
| TS1 ≧ 10(MPa) | ◯ | ◯ | X | ◯ | ◯ |
| TE1 ≧ 30(%) | ◯ | ◯ | ◯ | X | X |
| E2 ≧ 20(MPa) | ◯ | ◯ | ◯ | ◯ | X |
| Cabling evaluation | ◯ | X | X | X | X |

From the result of table 3, it is admitted that the damage to the optical fiber tape unit 12 can be prevented when cabling the optical fiber tape unit, when the Young's modulus E1, the cross-sectional area A1, the tensile strength TS1, and the tensile elongation TE1 of the overcoat layer of the optical fiber core and the Young's modulus E2, the cross-sectional area A2, the tensile strength TS2, and the tensile elongation TE2 of the connecting member of the optical fiber unit satisfy the relations E1≧100 (MPa), TS1≧10 (MPa), TE1≧30(%), and E2≧20 (MPa).

### EXAMPLE 4

Plural types of samples of the 4-core optical fiber tape unit were manufactured experimentally, and the single core separation evaluation was conducted by the single core separation process. Table 4 shows the result. The single core separation time means the time required for one worker to separate 10 tape units into single core.

TABLE 4

| Item | A | | B | | C | | D | |
|---|---|---|---|---|---|---|---|---|
| the outer diameter of the | 0.5 | mm | 0.5 | mm | 0.5 | mm | 0.5 | mm |
| optical fiber core | | | | | | | | |
| Young's modulus E1 of the | 230 | MPa | 230 | MPa | 230 | MPa | 230 | MPa |
| overcoat layer | | | | | | | | |
| Cross-sectional area A1 of | 0.581 | mm² | 0.581 | mm² | 0.581 | mm² | 0.581 | mm² |
| the overcoat layer (total | | | | | | | | |
| of four) | | | | | | | | |
| Tensile strength TS1 of | 31 | MPa | 31 | MPa | 31 | MPa | 31 | MPa |
| the overcoat layer | | | | | | | | |
| Tensile elongation TE1 of | 38% | | 38% | | 38% | | 38% | |
| the overcoat layer | | | | | | | | |
| Young's modulus E2 of the | 75 | MPa | 75 | MPa | 75 | MPa | 75 | MPa |
| connecting member | | | | | | | | |
| Cross-sectional area A2 of | 0.411 | mm² | 0.411 | mm² | 0.411 | mm² | 0.411 | mm² |
| the connecting member | | | | | | | | |
| Tensile strength TS2 of | 13 | MPa | 13 | MPa | 13 | MPa | 13 | MPa |
| the connecting member | | | | | | | | |
| Tensile elongation TE2 of | 22% | | 22% | | 22% | | 22% | |
| the connecting member | | | | | | | | |
| Addition of parting agent | No | | Yes | | No | | Yes | |
| to the overcoat layer | | | | | | | | |
| Addition of parting agent | No | | No | | Yes | | Yes | |
| to the connecting member | | | | | | | | |
| The single core separation | 92 | seconds | 84 | seconds | 73 | seconds | 60 | seconds |
| time | | | | | | | | |

From the result of table 4, it is admitted that the single core separation time shortens, namely, the single core separation performance is improved by mixing the parting agent with either one or both of the overcoat layer and the connecting member.

### EXAMPLE 5

The coating removal power of the experimentally manufactured optical fiber core was discussed. FIG. 8 shows a method of conducting a coating removal test. The optical fiber cores 10 with an outer diameter of 0.4 mm and 0.5 mm are used and cut by a blade 28 for coating removal in a circumferential direction of the overcoat layer 13 at a region distant by 100 mm from an edge of the optical fiber core not to damage the optical fiber core, and the blade 28 is moved in a direction horizontal to the optical fiber core 10 to remove the overcoat layer 13. Then, the maximum removal power at that time was measured with the tension measuring instrument. Table 5 and Table 6 show the result.

TABLE 5
For the optical fiber core with an outer diameter of 0.4 mm

| Item | A | B | C | D | E |
|---|---|---|---|---|---|
| Coating removal | 20 N/100 mm | 12 N/100 mm | 9.7 N/100 mm | 6.1 N/100 mm | 3.3 N/100 mm |
| power | | | | | |
| Appearance after the | Damage at | Damage at | No | No | No |
| coating is removed | peeling edge | peeling edge | problem | problem | problem |
| Evaluation | X | X | ◯ | ◯ | ◯ |

TABLE 6
For the optical fiber core with an outer diameter of 0.5 mm

| Item | A | B | C | D | E |
|---|---|---|---|---|---|
| Coating removal | 25 N/100 mm | 13 N/100 mm | 10.8 N/100 mm | 9.8 N/100 mm | 5.5 N/100 mm |
| power | | | | | |
| Appearance after the | Damage at | Damage at | Damage at | No | No |
| coating is removed | peeling edge | peeling edge | peeling edge | problem | problem |
| Evaluation | X | X | X | ◯ | ◯ |

From the results in Table 5 and Table 6, it is admitted that the damage on the optical fiber strand can be prevented by providing the coating removal power of the optical fiber core of 9.8 N/100 mm or less per one.

### EXAMPLE 6

Various types of samples of the optical fiber core were manufactured and the core identification property was examined. The core identification examination was conducted as follows: 40 cores with the same core diameter (50 cm) are bundled and fixed at both ends, and counted by arbitrary selected 15 persons who are from 20 years old up to 50 years old, then correct answer rates of the number (identification accuracy rate) and the required time (identification time) are evaluated. The core diameter of 0.25 mm is the one without the overcoat layer. Table 7 and Table 8 show the result.

TABLE 7
The case where the overcoat layer is colored

| | Core diameter | | | | |
|---|---|---|---|---|---|
| | 0.25 mm | 0.4 mm | 0.5 mm | 0.7 mm | 0.9 mm |
| Identification | 87% | 100% | 100% | 100% | 100% |
| correct answer rate | | | | | |
| Average | 54 seconds | 46 seconds | 40 seconds | 37 seconds | 32 seconds |
| identification time | | | | | |
| The maximum | 76 seconds | 66 seconds | 61 seconds | 52 seconds | 47 seconds |
| identification time | | | | | |

TABLE 8
The case where the overcoat layer is transparent

| | Core diameter | | | | |
|---|---|---|---|---|---|
| | 0.25 mm | 0.4 mm | 0.5 mm | 0.7 mm | 0.9 mm |
| Identification | 87% | 100% | 100% | 100% | 100% |
| correct answer rate | | | | | |
| Average | 54 seconds | 46 seconds | 41 seconds | 39 seconds | 50 seconds |
| identification time | | | | | |
| The maximum | 76 seconds | 64 seconds | 60 seconds | 54 seconds | 69 seconds |
| identification time | | | | | |

From the result in Table 7 and Table 8, it is admitted that the core identification property is excellent when the outer diameter of the optical fiber core is 0.4 mm or more. Further, from the result of the case where the overcoat layer is transparent, it is admitted that the core identification property is excellent when the outer diameter of optical fiber core 10 is from 0.4 mm to 0.7 mm because of the influence of the lens effect brought by a transparent overcoat layer.

The optical fiber colored strand can be classified with color by providing the transparent connecting member, so as to realize an excellent identification property of the optical fiber tape unit during the cabling process. Further, the core identification property can be improved to be colored by mixing the colorant with the connecting member itself when the colors of all optical fiber cores are same. Further, the connecting member may be provided with the stripe shaped color band.

### EXAMPLE 7

As example 7, an optical fiber core used for the optical fiber tape unit was manufactured. This method for fabricating an optical fiber core will be described below referring to FIG. 1.

On an optical fiber 17 with an outer diameter of about 0.125 mm, a primary coating layer 16 and a secondary coating layer 15 composed of an ultraviolet curing resin were formed to have the outer diameter of about 0.245 mm. Further, a colored layer 14 for identification was provided as an outermost layer to form an optical fiber strand with an outer diameter of about 0.255 mm.

Next, an overcoat layer 13 composed of an ultraviolet curing resin was formed on the optical fiber strand to obtain an optical fiber core 10 with an outer diameter of about 0.50 mm. The overcoat layer 13 has a Young's modulus of about 230 MPa, a tensile strength of about 31 Mpa and a cross-sectional area of about 0.145 mm².

To realize the excellent core identification property during the single core separation process, following two methods can be used:

(1) To cover the transparent overcoat layer having the lens effect in cylindrical shape on the optical fiber strand. This lens effect is specifically effective when the outer diameter of the optical fiber core is 0.7 mm or less (the colored outer diameter/the outer diameter of the overcoat layer≧37%); and

(2) To cover the overcoat layer colored by mixing with the colorant in cylindrical shape on the optical fiber strand.

### EXAMPLE 8

As example 8, an optical fiber tape unit was manufactured. This method for fabricating an optical fiber tape unit will be described below referring to FIG. 2.

An optical fiber tape unit 12 has a major axis of about 2.05 mm and a minor axis of about 0.52 mm, and four optical fiber cores 10 are connected with an ultraviolet curing resin. A connecting member 11 has a Young's modulus of about 75 MPa, a tensile strength of about 13 MPa, a tensile elongation of about 22%, and a cross-sectional area of about 0.411 mm². The relationship between the Young's modulus E1, the cross-sectional area A1, the tensile strength TS1 and the tensile elongation TE1 of the overcoat layer and the Young's modulus E2, the cross- sectional area A2, the tensile strength TS2 and the tensile elongation TE2 of the connecting member in the optical fiber tape unit is expressed as E1·A1−E2·A2≈102.6 ≧0, TS1−TS2=18>0, TE1−TE2=16>0 and E1≧100 (MPa), 20≦E2 ≦300 (MPa), TS1≦10 (MPa), TS2 ≦40 (MPa), TE1≦30(%), and TE2 ≦40(%).

When separating this optical fiber tape unit 12 into four optical fiber cores 10 (single cores) by the hand work, an excellent single core separation performance was obtained without destroying the overcoat layer in the optical fiber core 10. Further, the optical fiber loss will not increase during the separation process. Further, the optical fiber core can be easily identified during the separation process since the optical fiber core is 0.5 mm that is thick enough.

When fabricating the optical fiber tape unit 12, the following four methods can be used:

(1) To arrange a plurality of the optical fiber cores 10 in parallel, then apply an ultraviolet curing resin or a thermosetting resin on either one or both sides that correspond to long sides of the substantially rectangular cross-section formed by a plurality of the optical fiber cores 10 (for example, FIGS. 2, 3, 4 and 5);

(2) To arrange a plurality of the optical fiber cores 10 in parallel, then cover and cure the ultraviolet curing resin, the thermosetting resin or the thermoplastic resin by a pressurizing die (for example, FIGS. 2 and 4);

(3) To arrange a plurality of the optical fiber cores 10 in parallel, then apply and cure an adhesive on either one side or both sides that correspond to a long side of the substantially rectangular cross-section formed by a plurality of the optical fiber cores 10 (for example, FIGS. 3 and 5).

(4) To arrange a plurality of the optical fiber cores 10 in parallel, then apply and cure the ultraviolet curing resin, the thermosetting resin, the thermoplastic resin-ultraviolet curing resin, or the adhesive resin intermittently.

### EXAMPLE 9

As example 9, an optical fiber tape unit was manufactured. This method for fabricating an optical fiber tape unit will be described below referring to FIG. 6.

A cable part 18 is construed by arranging 6 pieces of the optical fiber tape units 12 in the middle and 2 pieces on its both sides, assembling and twisting with polypropylene system fiber (filler 26), roughly winding by a cotton string and covering with a sheath 20. The cable part 18 has an outer jacket thickness of 2.0 mm and an outer diameter of 9.5 mm. A steel wire with a diameter of 0.7 mm is used as the tension member 23, and a string of polyester system fiber with a diameter of 1.0 mm is used as a string 21 for ripping out the sheath. Further, a Zn-plated steel twisted wire composed of twisted seven steel wires with a diameter of 1.4 mm as a supporting line part 19, and a sheath 25 is formed around an outer circumference thereof. Then, a neck part 24 having slits with a constant interval is formed between the cable part 18 and the supporting line part 19, such that a loose rate of the cable part 18 against the supporting line part 19 becomes 0.2% or more. The sheath 20 of the cable part 18, the sheath 25 of the supporting line part 19, and the neck part 24 are formed simultaneously by extruding a low density polyethylene that is the thermoplastic resin to coat them in one bundle. This optical fiber cable has a total height of 17 mm.

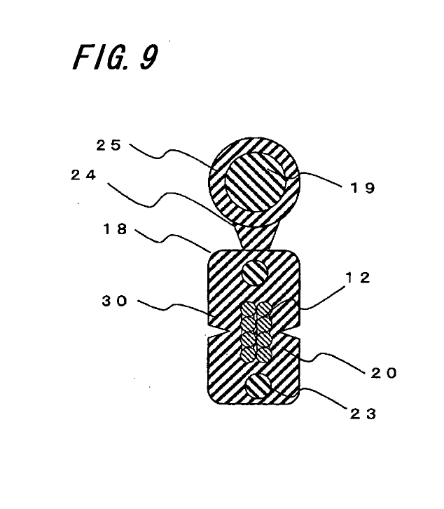

FIG. 9 is a schematic cross-sectional view showing the optical fiber cable in another preferred embodiment according to the invention.

The method for fabricating an optical fiber cable (so-called optical Drop cable) will be described below referring to FIG. 9.

To provide the cable part 18, the two optical fiber tape units 12 mentioned above are arranged in the middle, a steel wire with a diameter of 0.7 mm is used as the tension member 23 and the steel wire with a diameter of 2.3 mm is used as the supporting line 19, and the low density polyethylene that is thermoplastic resin is extruded to cover them in one bundle. Further, a notch 30 with a width of 1.2 mm and a depth of 0.9 mm in a longitudinal direction of the cable is formed, such that this optical fiber tape unit can be easily taken out from the sheath 20 of the cable part 18. This optical Drop cable has a width of 5.1 mm and a thickness of 3.5 mm, and a total cable height of 8.6 mm at the cable part 18.

### INDUSTRIAL APPLICABILITY

The optical fiber tape unit according to the invention is formed as follows: an optical fiber core provided with an overcoat layer to have an outer diameter of 0.4 mm or more is used, and a plurality of the optical fiber cores are arranged in parallel and connected by a connecting member in that following relations are satisfied: E1·A1≧E2·A2, TS1≧TS2, and TE1≧TE2, when the overcoat layer has a Young's modulus E1, a cross-sectional area A1, a tensile strength TS1 and a tensile elongation TE1, and the connecting member has a Young's modulus E2, a cross-sectional area A2, a tensile strength TS2 and a tensile elongation TE2. According to this structure, since the overcoat layer in the optical fiber core becomes stronger than the connecting member, the single core separation process can be conducted by destroying only the connecting member without destroying the overcoat layer during the single core separation process.

Since the optical fiber cable according to the invention comprises the optical fiber tape units, it can be easily handled when branching.

Although the invention has been described with respect to specific embodiment for complete and clear disclosure, the appended claims are not to be thus limited but are to be constructed as embodying all modification and alternative constructions that may be occurred to one skilled in the art which fairly fall within the basic teaching herein set forth.

1. An optical fiber tape unit, comprising:
an optical fiber core with an outer diameter of 0.4 mm or more, the optical fiber core including an optical fiber strand composed of an optical fiber, a primary coating layer and a secondary coating layer, and an overcoat layer formed around an outer circumference of the optical fiber strand; and
a connecting member for connecting a plurality of the optical fiber cores arranged in parallel;
wherein:
following relations are satisfied:
E1·A1≧E2·A2,
TS1≧TS2,
TE1≧TE2,
E1≧100 (MPa),
20≦E2≦300 (MPa)
TS1≧10 (MPa)
TS2≦40 (MPa),
TE1≧30(%), and
TE2≦40(%),
When the overcoat layer has a Young's modulus E1, a cross-sectional area A1, a tensile strength TS1 and a tensile elongation TE1, and the connecting member has a Young's modulus E2, a cross-sectional area A2, a tensile strength TS2 and a tensile elongation TE2.

2. The optical fiber tape unit, according to claim 1, wherein:
at least one of the overcoat layer and the connecting member contains a parting agent.

3. The optical fiber tape unit, according to claim 1, wherein:
the optical fiber strand is provided with a colored layer formed around an outer circumference of the secondary coating layer.

4. The optical fiber tape unit, according to claim 1, wherein:
the overcoat layer and the connecting member are composed of a thermosetting resin or a thermoplastic resin.

5. The optical fiber tape unit, according claim 1, wherein:
the overcoat layer is transparent.

6. The optical fiber tape unit, according to claim 1, wherein:
the overcoat layer is colored by a colorant.

7. The optical fiber tape unit, according to claim 1, wherein:
the connecting member is transparent.

8. The optical fiber tape unit, according to claim 1, wherein:
the connecting member is colored by a colorant.

9. The optical fiber tape unit, according to claim 1, wherein:
the connecting member has a stripe-shaped color band.

10. The optical fiber tape unit, according to claim 1, wherein:
the connecting member is formed on both sides that correspond to long sides of a substantially rectangular cross-section formed by arranging a plurality of the optical fiber cores in parallel.

11. The optical fiber tape unit, according to claim 1, wherein:
the connecting member is formed on one side corresponds to a long side of a substantially rectangular cross-section formed by arranging a plurality of the optical fiber cores in parallel.

12. The optical fiber tape unit, according to claim 10, wherein:
the connecting member is formed only on a concave portion between a plurality of the optical fiber cores arranged in parallel.

13. An optical fiber cable formed to be a cable by assembling one or more of the optical fiber tape units according to claim 1.

14. The optical fiber tape unit, according to claim 2, wherein:
the optical fiber strand is provided with a colored layer formed around an outer circumference of the secondary coating layer.

15. The optical fiber tape unit, according to claim 2, wherein:
the overcoat layer and the connecting member include a thermosetting resin or a thermoplastic resin.

16. The optical fiber tape unit, according to claim 2, wherein:
the overcoat layer is transparent.

17. The optical fiber tape unit, according to claim 2, wherein:
the overcoat layer is colored by a colorant.

18. The optical fiber tape unit, according to claim 2, wherein:
the connecting member is transparent.

19. The optical fiber tape unit, according to claim 2, wherein:
the connecting member is colored by a colorant.

20. The optical fiber tape unit, according to claim 2, wherein:
the connecting member has a stripe-shaped color band.
